(19) United States
(12) Patent Application Publication
(10) Pub. No.: US 2014/0189018 A1
(43) Pub. Date: Jul. 3, 2014

(54) SYSTEM AND METHOD FOR ELECTRONIC AND PHYSICAL DELIVERY OF MAIL

(71) Applicant: PITNEY BOWES INC., Stamford, CT (US)

(72) Inventors: Yassir Nawaz, Hamden, CT (US); Frederick W. Ryan, JR., Oxford, CT (US); Femi Olumofin, Shelton, CT (US)

(73) Assignee: PITNEY BOWES INC., Stamford, CT (US)

(21) Appl. No.: 13/730,147

(22) Filed: Dec. 28, 2012

(51) Int. Cl. H04L 12/58; G06F 17/30

(52) U.S. Cl. CPC H04L 12/581; G06F 17/30424
USPC 709/206; 707/758; 700/227

(57) ABSTRACT

Systems and methods for utilizing a digital mailbox to provide additional services with regard to physical mail are provided. A more efficient process for verification of address uses a corresponding digital mailbox to first identify potentially misdirected mailpieces before incurring the expense of a third party address record search. Additionally the system provides notifications related to physical mailpieces using a digital mailbox.

### TECHNICAL FIELD

The illustrative embodiments of the present invention relate generally to mail delivery systems and, more particularly, to a new and useful system and method for utilizing a digital mailbox to provide additional services with regard to physical mail.

### BACKGROUND

Systems and methods have been described for electronic delivery of mail including those that determine a confidence level that a recipient has moved. For example, U.S. Patent Application Publication No. 2011/0087746 A1, entitled System and Method for Electronic Delivery of Mail, published Apr. 14, 2011 by Sagi, et al., describes such a process used with digital mail systems.

In the United States, many people move to a new physical address every year. According to the United States Postal Service (“USPS”), the USPS processes approximately 46 million address change requests every year. The USPS and its vendors make available the National Change of Address (“NCOA”) database to volume mailers to reduce addressing errors. The NCOA database information is reported by individuals, families and businesses who decide to report their change of address information to the USPS. In certain alternatives to embodiments herein, the NCOA database can be replaced or augmented with similar change of address databases maintained by postal services or other organizations. In many cases, individual household members move from the address while the other household members remain at the address. Furthermore, estimates suggest that 15-20% of the population moves without reporting the change of address.

When a mailpiece is misdirected and sent to a recipient's old address, the mailpiece might be discarded or returned to the sender. If discarded, the recipient would never know that the mailpiece was sent. If returned to sender and if such a sender were to investigate and locate the current address, the original recipient might receive the mailpiece within a few weeks. Moreover, the sender incurs significant costs for physical mail that is undeliverable as addressed and returned to sender.

Accordingly, there is a need, among other needs, for systems and methods to utilize a digital mailbox system to provide additional services for physical mail delivery. There is a need for systems and methods that provide less expensive change of address queries. Additionally, there is a need for systems and methods to efficiently process address change data and to efficiently process information related to misdirected physical mailpieces including notification and rerouting information.

### SUMMARY

Systems and methods for utilizing a digital mailbox to provide additional services with regard to physical mail are provided. In certain embodiments, systems and methods to process physical mailpieces including more efficient verification of address using a corresponding digital mailbox are provided. In certain embodiments, the system obtains address data and determines that a mailpiece may be misdirected by accessing information relating to a corresponding digital mailbox. A more expensive change of address check such as NCOA may then be utilized to find readdressing information. The process may be used with systems of varied range including with the frontend document composition processing of an automated document factory all the way to use with a mailing machine having a scanner.

A misdirected mailpiece may be delivered, delivered with additional notifications, out-sorted from the mail stream or readdressed. Depending on the type and/or value of the mailpiece, the system may first interrogate the digital mailbox system and then utilize the traditional National Change of Address database information in order to process a change of address before delivery. Information regarding a potentially misdirected mailpiece identified by these methods may be sent to the recipient, sender, misdirected recipient, third- party processor and carrier as appropriate such as by email or by induction into a digital mailbox. An intended recipient may also be provided options with regard to redelivery.

In certain additional embodiments, systems and methods for using a digital mailbox to provide delivery estimate and tracking information relating to the delivery of a physical mailpiece from a sender to a recipient having a physical address are provided.

In certain additional embodiments, systems and methods for processing notifications relating to the delivery of a physical mailpiece from a sender to a recipient having a physical address are provided.

### BRIEF DESCRIPTION OF THE DRAWINGS

The accompanying drawings show illustrative embodiments of the invention and, together with the general description given above and the detailed description given below serve to explain certain principles of the invention. As shown throughout the drawings, like reference numerals designate like or corresponding parts.

FIG. 1 is a diagram showing a system and information flow for providing distribution of mail with enhanced services using a digital mailbox according to an illustrative embodiment of the present application.

FIG. 2 is a flow diagram showing a process for providing distribution of mail with enhanced services using a digital mailbox according to an illustrative embodiment of the present application.

### DETAILED DESCRIPTION

The present invention is described in the context of illustrative embodiments directed to new and useful systems and methods for processing mail. Systems and methods for utilizing a digital mailbox to provide additional services with regard to physical mail are provided. A digital mailbox system employs a server to host a digital mailbox associated with a corresponding physical address for the user.

It is now appreciated that information obtained from a physical mail processing system such as Automated Document Factory (ADF) or mailing machine having a postage meter and scanner may be used to provide additional services for physical mail by utilizing a digital mailbox environment. For example, the information obtained from a physical mailpiece composition system or a physical mailpiece may be matched to the name of the corresponding digital mailbox owner in order to determine whether a particular mailpiece might be misdirected to an incorrect or stale address.

In certain embodiments, systems and methods to process physical mailpieces including more efficient verification of address using a corresponding digital mailbox are provided. In certain embodiments, the system obtains address data and determines that a mailpiece may be misdirected by accessing information relating to a corresponding digital mailbox. A more expensive change of address check such as NCOA may then be utilized to find readdressing information. The process may be used with systems of varied range including with the frontend document composition processing of an automated document factory all the way to use with a mailing machine having a scanner.

A misdirected mailpiece may be delivered, delivered with additional notifications, out-sorted from the mail stream or readdressed. Depending on the type and/or value of the mailpiece, the system may first interrogate the digital mailbox system and then utilize the traditional National Change of Address database information in order to process a change of address before delivery. Information regarding a potentially misdirected mailpiece identified by these methods may be sent to the recipient, sender, misdirected recipient, third- party processor and carrier as appropriate such as by email or by induction into a digital mailbox. An intended recipient may also be provided options with regard to redelivery.

In certain additional embodiments, systems and methods for using a digital mailbox to provide delivery estimate and tracking information relating to the delivery of a physical mailpiece from a sender to a recipient having a physical address are provided. In certain additional embodiments, systems and methods for processing notifications relating to the delivery of a physical mailpiece from a sender to a recipient having a physical address are provided.

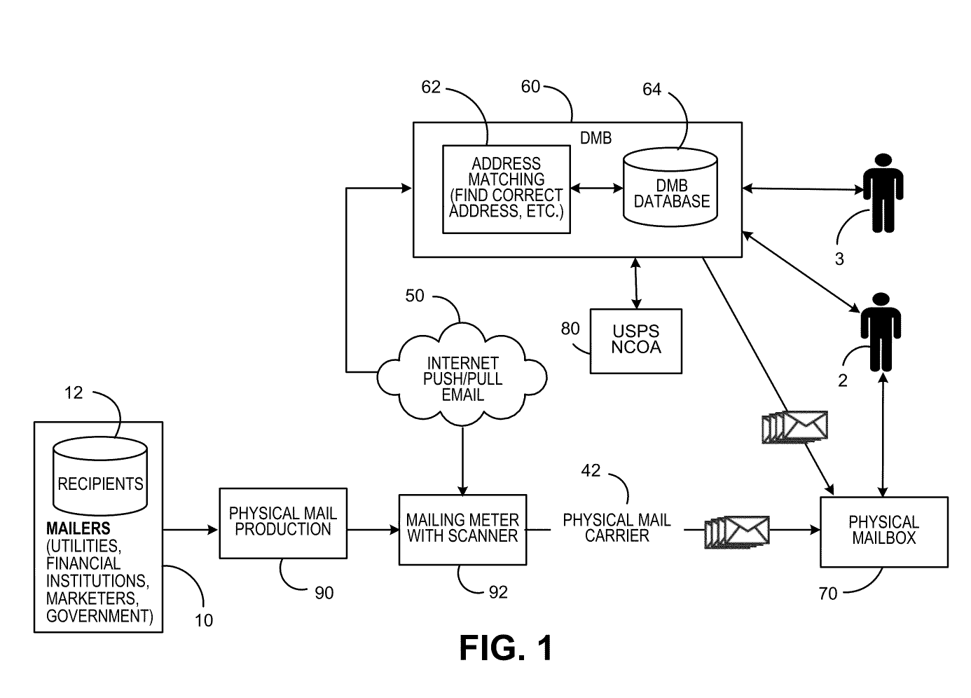

Referring to FIG. 1, a diagram showing a system and information flow for providing distribution of mail with enhanced services using a digital mailbox according to an illustrative embodiment of the present application is shown. The mail production system shown is a mail creation, finishing and delivery service that is constructed as a physical (10, 90) and electronic (not shown) automated document factory (ADF). The electronic production portion is not shown to simplify the figure and would include a “split-stream” ADF with a digital content server. A digital mailbox user 3 would receive digitally delivered full mailpieces.

In this configuration, several mailers 10 utilize information technology and data processing systems to deliver among other data, print streams 14 that may include use of recipient information 12. Typical mailers 10 include organizations that create and deliver transactional and periodic physical communications that are often sent by first class mail such organizations including utilities, financial institutions, marketers and government agencies. The physical mail will be sent to the physical mailbox 70 of mail carrier user 2. In this case, mail carrier user 2 also has a corresponding digital mailbox in digital mailbox environment 60.

In one embodiment, prior to printing the physical mail in production 90, the system provides an enhanced, efficient delivery address verification for at least some of the mailpieces sent by the physical channel. The enhanced address verification involves first querying a digital mailbox system to identify potentially misdirected mailpieces and only for potentially misdirected pieces, then accessing a charged service such as a National Change of Address (NCOA) based address verification service 80. In this embodiments, mailpieces that are confirmed misdirect, are updated before printing in the physical mail production system 90.

In another embodiment, a mailing machine including a postage meter with an envelope scanner 92 is used. After production, or for smaller mailers, after individual mailpieces are created, the system determines of the mailpiece is misdirected as above. If a misdirected mailpiece is detected, it may or may not be corrected depending on the business logic rules applied. The mailpiece might be out-sorted for correction or not, and in either case would be placed in the physical mailstream of the physical mail carrier 42. Here, the physical mail carrier 42 is the United States Postal Service, but other carriers may be used. The mailpiece is then delivered to the physical mailbox 70.

The envelope scanner may be used with an Optical Character Recognition (OCR) system to obtain recipient and address information. A network such as the Internet 50 along with web services and/or push/pull email can be utilized to communicate with the digital mailbox environment 60. The digital mailbox environment 60 includes an address matching logic application 62 to apply the address matching request logic and respond to queries using the digital mailbox database 64. One or more data communications channels including secure internet channels such as a VPNs and or a dedicated line may be used.

In one embodiment, the recipient and destination address data or image including that data are sent to the DMB 60. The DMB 60 then uses OCR if needed and the DMB database 64 to determine if the recipient and destination address match the corresponding digital mailbox as a first level determination—yes or no. If yes, the mailpiece is likely accurate and is processed, without incurring any additional cost of an NCOA check. If the recipient and destination address do not match, the system may make a second level determination if requested or setup to continue further, such as for valuable mailpieces or those that have high costs for undeliverable as addressed mail. For example, credit card bills may be set for second level processing. If that recipient was ever associated with that digital mailbox associated with the destination address, the DMB system may determine if the user is associated with a new digital mailbox and may return such information if requested or setup to. The DMB system (or alternatively another server in the system) may also be configured to incur the expense of performing an NCOA check 80 to obtain the latest USPS address for that recipient in order to return the information to the sender. The sender may then correct the mailpiece to avoid the costs associated with an undeliverable as addressed mailpiece. Information regarding a potentially misdirected mailpiece identified by these methods may be sent to the recipient, sender, misdirected recipient, third-party processor and carrier as appropriate such as by email or by induction into a digital mailbox.

An intended recipient may also be provided options with regard to redelivery. For example, if mailpiece correction or redirection is not possible or desirable, the recipient may be sent an electronic message at the recipient's new digital mailbox notifying the recipient of the misdirected mailpiece. The recipient may be then afforded the opportunity to request redelivery to the correct address using a web interface to the server. Additionally, the server may send the intended recipient a notice at the new digital mailbox that includes a hyperlink or other instructions pointing to the USPS online change of address service.

In certain additional embodiments, systems and methods for using a digital mailbox to provide delivery estimate and tracking information relating to the delivery of a physical mailpiece from a sender to a recipient having a physical address are provided. For example, if the mailpiece is correctly addressed, a copy of the scanned image or a digital print image of the face of the envelope is sent into the corresponding digital mailbox. There, the recipient may receive an estimated delivery date or push and or pull tracking information. The image may be placed in a physical mail folder in the digital mailbox and may also or alternatively be placed in a folder associated with a particular date, sender or type of mailpiece.

In certain additional embodiments, systems and methods for processing notifications relating to the delivery of a physical mailpiece from a sender to a recipient having a physical address are provided. For example, if a copy of the mailpiece is correctly or incorrectly addressed, a copy of the face of the mailpiece may be placed in the appropriate digital mailbox. A notice may be sent by email to the sender when the recipient views the notification. In an alternative, the sender may optionally request to receive a notice via email when the recipient views the notification. In certain embodiments, a recipient can deny the system from sending a notice to the sender. In another embodiment, the system always sends a notice when a recipient views a notification. In the latter embodiment, the recipient's only way of denying notices is to not view a notification.

In an additional embodiment, the system captures mail piece images from mailing machines including postage meters, whereby the images are uploaded to a digital mailbox DMB environment for processing. The system includes a postage meter system equipped with a camera to capture images of the mail pieces and the ability to send these images via internet to a digital mailbox (DMB) Service. Alternatively the system could also utilize a standalone or other scanner at the mailer/sender facility that can scan a face of a mail piece and upload the image or OCR information to the DMB through an internet connection.

In one configuration, a camera on the postage meter captures image of each mail piece as it goes through the postage meter. The captured image of the face of the mail piece is processed through OCR to extract the text on the face of the envelope. This includes name of the recipient, address, sender name, marketing messages etc. Additional image processing might be done to extract logo etc. This processing can alternatively be done at the DMB service. Also note that this information can also be obtained directly from the database without using a camera on the postage meter. A DMB service where each digital mailbox is tied to a fixed address (physical mailbox) can be utilized. The digital mailbox that corresponds to an address is claimed by the person(s) living at that address by proving their residence at that address.

In one illustrative process, the system captures an image of each mail piece, extract information from it, including name, address, etc. It then uploads the image and/or extracted information to the DMB service. The DMB service compares the name and address extracted from the envelope to the corresponding digital mailbox information. If the information matches, it puts the image of the face of the envelope in that digital mailbox along with relevant information, i.e. date and time of image capture etc. This image can additionally be categorized and filed in the digital mailbox based on the sender, type of mail (utility bill, financial bill, etc.). It can also be categorized as physical mail (goes in physical mail folder). Additional information such as estimated delivery etc. can also be provided by the service in addition to the image.

When the owner of the digital mailbox logs in to their mailbox, the owner can access the image and know about the incoming piece of physical mail. Upon accessing the image, the fact that recipient is aware of an incoming piece of physical mail can also be transmitted back to the mailer by the service. The DMB service may also keeps track of the current and previous owners of each digital and its corresponding physical mail box. When an image of an incoming mail piece is uploaded to the service and the name extracted from the mail piece does not match the name of the current owner of that digital mailbox, the service can determine if the recipient has moved. The DMB can compare the recipient's name with the previous owner of the address to which the communication is being sent. If there is a match the service knows that this recipient has moved. It can also check to see if the recipient has claimed a new digital mailbox corresponding to a new address. The recipient can then be notified (either at their new mailbox or via email, phone, SMS) that a piece of physical mail is being sent to their old address. The service can offer the recipient to take action to correct their address with the mailer or signup for mail forwarding etc. The DMB can also decide to forward the image of the mail to the new digital mailbox or old digital mailbox or both. Similarly this information can be provided to the United States Postal Service (USPS) or the applicable carrier.

Several illustrative hardware and software systems and subsystems are described herein that may advantageously utilize certain available components. For example, certain print-to-mail systems are available from the Pitney Bowes Emtex and Pitney Bowes Business Insight subsidiaries of Pitney Bowes Inc. located in Stamford, Conn. Systems herein may utilize Automated Document Factory (ADF) systems, print stream processing systems, document composition, printing, insertion and franking systems and electronic bill presentment and payment (EBPP) systems available from Pitney Bowes Inc. of Stamford Conn. including DFWORKS, MAILSTREAM ENGAGE, FLOWMASTER RS FLEX, MAILSTREAM EVOLUTION, FMI CUT SHEET FEEDER, FLEXIBLE BINDERY INTERFACE, EFS ENVELOPE FINISHING SYSTEM, DM INFINITY SERIES, the CONNECT+mailing machine, the PITNEY BOWES SERIES 11 inserter systems, and the PITNEY BOWES INTELLIJET printing system.

Additionally, any of the systems and subsystems described in U.S. Patent Application Publication No. 2011/0087746 A1 or its incorporated documents may alternatively used with any of the embodiments herein as appropriate. The servers described are typically INTEL architecture servers such as DELL servers using the WINDOWS SERVER operating system software and the databases utilize ORACLE database systems. Additionally, the illustrative embodiments are described as enhancements to previously commercially available software systems marketed by EMTEX available from Pitney Bowes Inc. of Stamford, Conn.

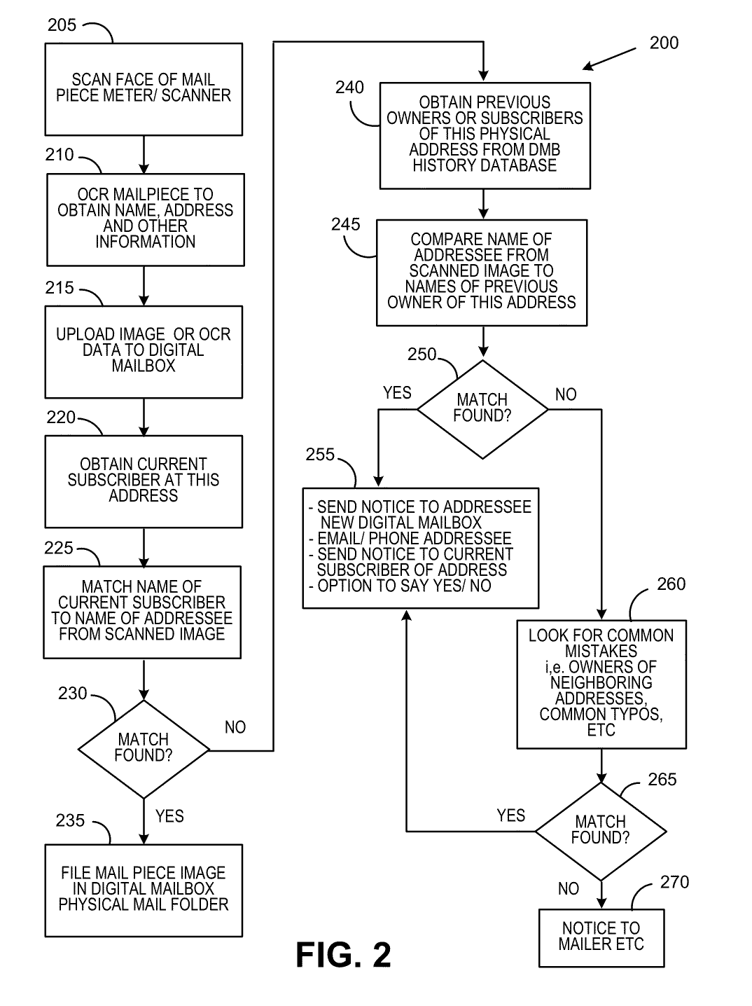

Referring to FIG. 2, a flow diagram showing a process 200 for providing distribution of mail with enhanced services using a digital mailbox according to an illustrative embodiment of the present application is shown. In step 205, the system scans the face of a mailpiece using a mailing machine or scanner. Alternatively, data or a print to file of a mailpiece face obtained from the frontend of an ADF may be used.

In step 210, if necessary, the system or DMB will OCR the mailpiece to obtain recipient name data, physical address data and other information including optionally sender identification information and sender contact metadata such as an email address. For example, a sender contact email address may be printed in a return address block or in another suitable location. In step 215, the system uploads the mailpiece face image or the OCR data to the digital mailbox environment. In step 220, the DMB system obtains the current subscriber identity for the digital mailbox that corresponds to that physical address. In step 225, the DMB system determines if the name of the current subscriber matches the name of the recipient on the scanned face of the mailpiece. In step 230, if there is a match, the DMB system files the mailpiece image in the digital mailbox. The mailpiece image may be stored in a folder used for incoming physical mail or may be placed in an appropriate folder based upon other criteria such as a date, sender identification and/or type of mailpiece. Additionally, the system may provide a delivery estimate field or a tracking field or hyperlink to provide tracking for the physical mailpiece through the carrier system.

In step 230, if there is no match, then the system may simply report that fact back to the mailpiece creation system as a first level indication. In such a case, the mailpiece generation system may then decide based upon business rules whether to incur the cost of a search of a third party change of address service such as one based upon the USPS NCOA system. For example, if the mailpiece is an advertisement, it may not be corrected, but the internal customer account may be flagged to check for an address update.

If a second level indication is requested or indicated, then in step 240 the system obtains the identity of previous owners of the corresponding digital mailbox to determine if there is a match to the current intended recipient of the physical mailpiece in question. The DMB system will have historical records of prior owners of such digital mailboxes in its database. In step 245, the system compares the name of the intended recipient from the scan or other mailpiece data to the names of the previous owners. In step 250, if there is a match, several helpful steps may be taken. For example, in step 255, the system may perform one or more of: a) sending a notice to the named addressee at his known new digital mailbox; b) sending an email or telephoning the intended recipient using digital mailbox system contact information; c) sending a notice to the current subscriber at that address and providing that current subscriber the option to accept or decline delivery. As can be appreciated, other corrective action may be taken with respect to notifications of the carrier, sender, intended recipient and/or current addressee.

If there is no match in step 250, then the process proceeds to step 260 and will search for common mistakes such as owners of neighboring addresses, common typographical errors, etc. If a match is found in step 265, then the system returns to the corrective actions of step 255. If no match is found in step 265, then final notice or corrective action such as notice to the mailer is provided in step 270.

In additional embodiments, the system captures images of a mailpiece such as by using a postage meter, extracting information from the image and uploading it to a server. The system links this information/recipient to a digital mailbox (DMB) and categorizes/files this information in that DMB based on the type and content of information. The system combines this information with DMB service's current and historic information to determine that a mail piece is being sent to an incorrect address, informing the correct recipient of this fact and providing them with options to take appropriate actions. The system may also have a “physical mail folder” in each digital mailbox and then file these images in the DMB in the incoming physical mail folder. The system may provide a notice to the sender when the recipient accesses the image of the incoming mail in their digital mailbox.

Although the invention has been described with respect to particular illustrative embodiments thereof, it will be understood by those skilled in the art that the foregoing and various other changes, omissions and deviations in the form and detail thereof may be made without departing from the scope of this invention.

What is claimed is:

1. A computer implemented method for processing addressee information relating to a physical mailpiece using a digital mailbox environment comprising:
obtaining addressee information including a recipient name and a recipient physical address associated with a physical mailpiece; and
determining if the address information matches digital mailbox address information of a digital mailbox associated with the physical address.

2. The method of claim 1, further comprising:
only if the addressee information does not match the digital mailbox addressee information, then determining if updated addressee information is available;
if updated address information is available, then updating the addressee information; and
creating the physical mailpiece using the updated addressee information.

3. The method of claim 1, wherein,
obtaining addressee information including a recipient name and a recipient physical address associated with a physical mailpiece further includes:
obtaining an image of a face of the physical mailpiece;
only if the addressee information does not match the digital mailbox addressee information, then determining if updated addressee information is available;
if updated address information is available, then updating the addressee information; and
creating the physical mailpiece using the updated addressee information.

4. The method of claim 3, further comprising:
performing an optical character recognition of the image to obtain the recipient name and the recipient physical address.

5. The method of claim 1, further comprising:
if the addressee information does match the digital mailbox addressee information, then
creating the physical mailpiece using the addressee information.

6. The method of claim 1, wherein,
determining if the address information matches digital mailbox address information of a digital mailbox associated with the physical address further includes requesting an address verification from a third party address vendor.

7. The method of claim 6, wherein,
the third party address vendor utilizes the United States Postal Service National Change of Address Database.

8. The method of claim 1, wherein,
obtaining addressee information including a recipient name and a recipient physical address associated with a physical mailpiece further includes:
obtaining an image of a face of the physical mailpiece; and
if the addressee information does match the digital mailbox addressee information, then
creating the physical mailpiece using the addressee information; and
storing the image of the face of the physical mailpiece in the digital mailbox associated with the physical address.

9. The method of claim 8, further comprising:
notifying a sender of the physical mailpiece when an owner of the digital mailbox associated with the physical address accesses the image of the face of the physical mailpiece stored in the digital mailbox.

10. The method of claim 1, further comprising:
only if the addressee information does not match the digital mailbox addressee information, then determining if a second digital mailbox is associated with the recipient name;
if the second digital mailbox is available, sending a notice to a owner of the second digital mailbox.

11. The method of claim 1, further comprising:
only if the addressee information does not match the digital mailbox addressee information, then determining if a second digital mailbox is associated with the recipient name;
if the second digital mailbox is available, sending a notice to a owner of the second digital mailbox including change of address instructions.

12. The method of claim 3, wherein,
obtaining an image of a face of the physical mailpiece further includes, scanning the face of the physical mailpiece using a mailing machine including a postage meter.

13. The method of claim 3, wherein,
obtaining an image of a face of the physical mailpiece further includes, scanning the face of the physical mailpiece using an inserter machine.

14. The method of claim 8, further comprising:
displaying delivery information associated with the physical mailpiece in the digital mailbox associated with the physical address.

15. A computer implemented method for processing notifications relating to the delivery of a physical mailpiece from a sender to a recipient having a physical address comprising:
receiving an image of a face of a physical mailpiece using the computer;
obtaining address data and recipient data from the image using the computer;
sending the image to a digital mailbox system for a digital mailbox assigned to the recipient and the physical address;
receiving an indication that the recipient has viewed the image in the digital mailbox from the digital mailbox system; and
notifying the sender that the recipient has viewed the image in the digital mailbox.

16. The method of claim 15, wherein:
the image of the face of the physical mailpiece is received from a postage meter.

17. The method of claim 15, wherein:
the image of the face of the physical mailpiece is received from a mailpiece sorter.
